(19) United States
(12) Patent Application Publication
(10) Pub. No.: US 2008/0082460 A1
(43) Pub. Date: Apr. 3, 2008

(54) RETIREMENT INCOME PLAN SYSTEMS AND METHODS

(75) Inventors: Matthew D. Hutcheson, Tigard, OR (US); Thomas L. Peterson, Tualatin, OR (US); Daniel S. Peterson, Tualatin, OR (US)

Correspondence Address: KOLISCH HARTWELL, P.C., 520 SW YAMHILL STREET, Suite 200, PORTLAND, OR, 97204, US

(73) Assignee: G FIDUCIARY, LLC, Tualatin, OR (US)

(21) Appl. No.: 11/859,695

(22) Filed: Sep. 21, 2007

Related U.S. Application Data
(60) Provisional application No. 60/846,793, filed on Sep. 22, 2006.
(60) Provisional application No. 60/889,224, filed on Feb. 9, 2007.

(51) Int. Cl. G06Q 90/00

(52) U.S. Cl. 705/36 R

(57) ABSTRACT

Systems and methods of implementing sponsored retirement income plans with all effective fiduciary discretion and responsibility residing with a fiduciary entity that is separate from a co-sponsor.

### RELATED APPLICATIONS

This application is based upon and claims priority under 35 U.S.C. § 119(e) to U.S. Provisional Application Ser. No. 60/846,793, entitled “INVESTMENT SYSTEM AND METHOD,” filed on Sep. 22, 2006, and U.S. Provisional Application Ser. No. 60/889,224, entitled “RETIREMENT INCOME PLAN METHODS,” filed on Feb. 9, 2007, the contents of which are hereby incorporated by reference in their entireties for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present disclosure relates generally to retirement income plans, and more particularly systems and methods of implementing sponsored retirement income plans.

In the United States, the Employee Retirement Income Security Act of 1974 (“ERISA”), and subsequent amendments, establishes standards for retirement plans. ERISA is embodied in the Unites States Code including Title 29, Chapter 18, the entire content of which is hereby incorporated by reference, as well as in portions of the United States Internal Revenue Code (“IRC”). Portions of the IRC relevant to retirement accounts include, Title 26, Subtitle A, Chapter 1, Subchapter D, and Subtitle D, Chapter 43, the entire contents of which are hereby incorporated by reference.

A traditional sponsor of a sponsored retirement plan is an employer that provides a 401(k) or other type of retirement plan as an employee benefit. Generally, one or more officers of the employer company act as fiduciaries for the plan. A fiduciary is defined at 29 U.S.C. § 1002(21)(A) as a person who “(i) . . . exercises any discretionary authority or discretionary control respecting management of [an employer-sponsored retirement] plan or exercises any authority or control respecting management or disposition of its assets, (ii) . . . renders investment advice for a fee or other compensation, direct or indirect, with respect to any moneys or other property of such plan, or has any authority or responsibility to do so, or (iii) . . . has any discretionary authority or discretionary responsibility in the administration of such plan.”

Note that a fiduciary is not only any person who has the authority to administer a plan, but is also any person who exercises any “discretionary control” over a plan. In other words, a person who may not have the authority to make decisions regarding a plan, yet is in a position to exercise discretion anyway, may be found to be a fiduciary. In such situations, he/she may be personally liable, and/or may open up his/her employer to liability, for improper and/or poor decisions.

Generally, one or more directors or officers of an employer-company act as the fiduciaries for the sponsored retirement plan. Under ERISA, fiduciaries must act solely in the interests of the participating employees and their beneficiaries, yet directors and officers have a separate duty to the shareholders of the company that sponsors the plan. Those two sets of fiduciary duties may conflict from time to time.

Furthermore, most directors and officers have duties that they consider to be of higher priority (e.g., running the company) than administering a retirement plan, and therefore do not devote the care and attention to the administration and management of the retirement plan that is demanded by fiduciary standards. In such situations, various tasks requiring fiduciary discretion are often delegated to individuals within the company, such as within a human resources department. Such persons rarely, if ever, have the appropriate expertise to make these important decisions. As decision-making tasks are delegated, the directors and officers are not only opening up the company to liability to plan participants for poor decision-making, but also themselves personally as well as their delegates personally. This scenario may be described as fiduciary drift and is a common basis for the hundreds of class action suits presently pending against employers, officers, and staff members.

### SUMMARY

The present disclosure relates to systems and methods of implementing sponsored retirement income plans with all effective fiduciary discretion and responsibility residing with a fiduciary entity that is separate from a co-sponsor (e.g., an employer having participating employees).

### BRIEF DESCRIPTION OF THE DRAWINGS

FIG. 1 is a diagram illustrating relationships and interactions between various entities and individuals associated with retirement income plan systems and methods according to the present disclosure.

FIG. 2 is a flow chart illustrating retirement income plan methods according to the present disclosure.

### DETAILED DESCRIPTION

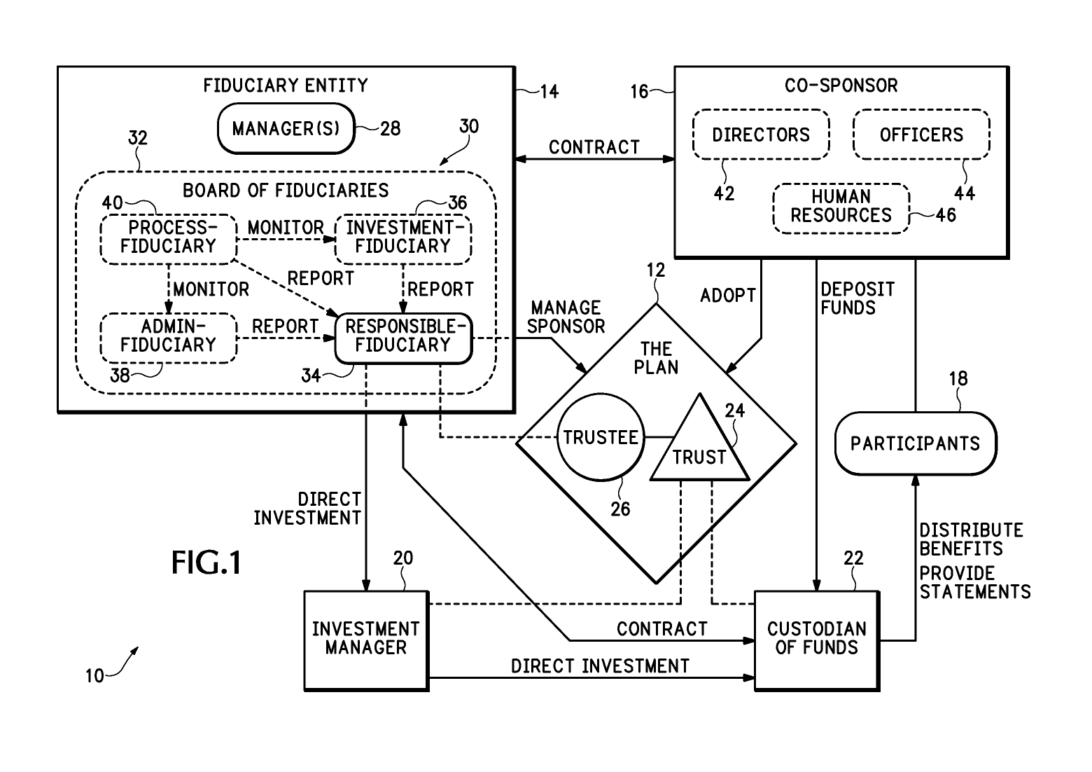

As broadly illustrated in FIG. 1, retirement income plan systems 10 according to the present disclosure may include one or more of (but are not limited to) a retirement plan 12, a fiduciary entity 14, a co-sponsor 16, a group of participants 18 associated with a co-sponsor 16, an investment manager 20, and/or a custodian of funds 22.

### I. Retirement Plans

A retirement plan 12 may also be described as a retirement income plan, an independent fiduciary plan for retirement income security, an employee benefit plan, an employee retirement plan, a pension plan, or any other appropriate designation generally referring to a retirement plan configured to provide retirement benefits to a group of participants associated with a co-sponsor, or formerly associated with a co-sponsor, such as an employer. In some instances, a retirement plan may be described as a qualified plan, for example as qualifying under appropriate sections ERISA or the IRC. A retirement plan may be a defined contribution plan, a defined benefit plan, or other type of plan.

As illustrated in FIG. 1, a plan 12 may include a trust 24 having a trustee 26; however, other configurations of retirement plans are equally within the scope of the present disclosure. In some instances, a retirement plan 12 and its associated trust may be intended to qualify as a tax-exempt profit-sharing plan and trust under IRC §§ 401(a) and 501(a), respectively. Additionally, a retirement plan 12 may include a cash-or-deferred arrangement forming part that is intended to qualify under IRC § 401(k).

Retirement plans 12 may be single co-sponsor plans, multiple co-sponsor plans, or any other appropriate type of retirement plan. For example, a retirement plan 12 may, though is not required to, qualify as a retirement plan subject to IRC § 413(b) or IRC § 413(c).

A non-exclusive example of a retirement plan that may be used according to systems and/or methods according to the present disclosure is described in Appendix A, below. Other retirement plans may equally be used without departing from the scope of the present disclosure.

Retirement plans 12 may require investment of retirement plan funds according to a predetermined methodology. For example, a retirement plan 12 may require investment of the retirement plan funds according to a nationally-recognized prudent retirement investment strategy. Additionally or alternatively, a retirement plan 12 may require investment of the retirement plan funds according to Harry Markowitz' Modern Portfolio Theory and subsequent evolutionary thought. Additionally or alternatively, a retirement plan may require investment in the range of about 30-50% of the retirement plan funds in broad fixed-income investments, investment in the range of about 50-70% of retirement plan funds in large cap equity investments, and investment in the range of about 0-10% of retirement plan funds in cash instruments. Additionally or alternatively, a retirement plan 12 may require investment of approximately 40% of retirement plan funds in broad fixed-income investments, and investment of approximately 60% of retirement plan funds in large cap equity investments.

A non-exclusive example of an investment policy statement that may correspond to a predetermined methodology of investment associated with a retirement plan 12 is provided in Appendix B, below.

### II. Fiduciary Entities

A fiduciary entity 14 may also be described as a principal plan sponsor, a plan sponsor, a sponsor, a manager, or any other appropriate designation generally referring to an individual or a business entity (such as a corporation, limited liability company, organization, association, etc.) responsible for sponsoring a retirement plan 12 for a co-sponsor 16. A non-exclusive example of an agreement between a retirement plan 12 and a fiduciary entity 14 establishing the fiduciary entity as the sponsor of a given retirement plan is provided in Appendix C, below.

In the instance of a fiduciary entity 14 being a business entity, such entity may include managers 28, or other officers, employees, directors, etc. associated with and responsible for the day-to-day operation of the business. The fiduciary entity 14 may also include, or be associated with, one or more individual fiduciaries 30. As used herein, an individual fiduciary is a person or entity that (i) exercises any discretionary authority or discretionary control with respect to management of a retirement plan 12 or with respect to disposition of plan assets; (ii) has authority or responsibility to render investment advice for a fee or other compensation with respect to assets of a retirement plan 12; or (iii) has any discretionary authority or responsibility in the administration of a retirement plan 12.

### A. Boards of Fiduciaries

In some instances, a fiduciary entity 14 may include a board 32 of individual fiduciaries 30. Such a board may include (but is not limited to) one or more of a responsible-fiduciary 34, an investment-fiduciary 36, an administrative-fiduciary 38, and/or a process-fiduciary 40. The one or more individual fiduciaries associated with a fiduciary entity 14 may be employees of the fiduciary entity, may be independent contractors for the fiduciary entity, or may have another contractual or business relationship with the fiduciary entity. As used herein, the phrase “associated with” does not require an employer/employee relationship.

A non-exclusive example of an agreement between a fiduciary entity 14 and an individual fiduciary 30 is provided in Appendix D, below. Though titled “Independent Investment Fiduciary Agreement,” the agreement is not limited to investment-fiduciaries 36 as described in more detail below, and may equally be used with, or modified for, other individual fiduciaries 30 associated with a fiduciary entity 14.

A fiduciary entity 14 may establish a standard of qualification for individual fiduciaries to be associated with the fiduciary entity. For example, prior to associating with a given individual fiduciary, a fiduciary entity may require the individual fiduciary to have a predetermined amount of industry experience, no affiliation with a broker-dealer or an insurance company, an accreditation from a predetermined body, a lack of a criminal record, and/or other predetermined qualifications. A non-exclusive example of a questionnaire that may be provided to individual fiduciaries by a fiduciary entity to aid in its determination of whether to associate with an individual fiduciary is provided in Appendix E, below. Though titled “Statement of Qualifications for Independent Investment Fiduciaries,” the questionnaire is not limited to investment-fiduciaries 36 as described in more detail below.

### B. Responsible-Fiduciaries

A responsible-fiduciary 34 is an individual fiduciary that has the ultimate discretion and responsibility with regard to the management and operation of a given retirement plan 12. In some systems according to the present disclosure a responsible-fiduciary may (though is not required to) also fulfill the role of the trustee 26 of the trust 24 associated with a given retirement plan 12. A non-exclusive example of an agreement defining a relationship and establishing an association between a fiduciary 14 entity and a responsible-fiduciary 34 is provided in Appendix F, below.

### C. Investment-Fiduciaries

An investment-fiduciary 36 is an individual fiduciary that may have responsibility for monitoring investments associated with management of a given retirement plan 12, and/or for verifying that the investments comply with the retirement plan's guidelines and fiduciary standards. In some systems and methods according to the present disclosure, an investment-fiduciary may qualify as a fiduciary because he/she has responsibilities associated with the administration of a given retirement plan; however, the investment-fiduciary may not have any actual discretionary authority relating to the administration of the retirement plan (e.g., may not have authority to make fiduciary decisions). An investment-fiduciary 36 reports to a responsible-fiduciary 34, who, as mentioned above, has the ultimate discretion and responsibility associated with the management and operation of a given retirement plan.

### D. Administrative-Fiduciaries

An administrative-fiduciary 38 is an individual fiduciary that may have responsibility for monitoring the payroll/contribution sequence associated with a given retirement plan. Stated differently, an administrative-fiduciary may have responsibility for monitoring the receipt and disbursement of a retirement plan's funds. In some systems and methods according to the present disclosure, an administrative-fiduciary may qualify as a fiduciary because he/she has responsibilities associated with the administration of a given retirement plan; however, the administrative-fiduciary may not have any actual discretionary authority relating to the administration of the retirement plan. An administrative-fiduciary 38 reports to a responsible-fiduciary 34, who, as mentioned above, has the ultimate discretion and responsibility associated with the management and operation of a given retirement plan.

### E. Process-Fiduciaries

A process-fiduciary 40 is an individual fiduciary that may have responsibility for monitoring the activities of other individual fiduciaries associated with a retirement plan. For example, a process-fiduciary may have responsibility for monitoring the activities of other board members associated with their respective delegated responsibilities. In some systems and methods according to the present disclosure, a process-fiduciary may qualify as a fiduciary because he/she has responsibilities associated with the administration of a given retirement plan; however, the process-fiduciary may not have any actual discretionary authority relating to the administration of the retirement plan. A process-fiduciary 40 reports to a responsible-fiduciary 34, who, as mentioned above, has the ultimate discretion and responsibility associated with the management and operation of a given retirement plan.

Fiduciary boards according to the present disclosure are not limited to the above-described individual fiduciaries. Other individual fiduciaries may be associated with a fiduciary entity and may have one or more responsibilities as generally described above relating to the responsibilities of a responsible-fiduciary, an investment-fiduciary, an administrative-fiduciary, and a process-fiduciary, as well as other responsibilities generally qualifying them as an individual fiduciary 30. Similarly, the above-titled individual fiduciaries are not limited to only having the responsibilities described herein. A non-exhaustive list of tasks that may be delegated to various fiduciaries associated with a fiduciary entity may include: (i) participate in regular conference calls with other fiduciaries; (ii) review periodic statements and reports; (iii) observe and monitor investment mechanics; (iv) verify that deposits are invested correctly; (v) periodically review plan documents and investment policy statement; (vi) periodically review funds; (vii) make changes to funds if necessary; (viii) review and consider economic considerations; (ix) review auto-rebalance process with third party administrator; (x) observe and monitor independent process and administrative fiduciaries; (xi) provide principal plan sponsor with periodic reports; (xii) attend and participate in annual independent fiduciary meeting; (xiii) review adherence to prudent process; (xiv) observe payroll/contribution sequence; (xv) correct payroll/contribution sequence flaws; (xvi) review fiduciary practices; (xvii) observe plan generally, including administration and investment mechanics; (xviii) identify and hire CPA firm for annual audit of plan; (xix) begin CPA audit; (xx) work CPA firm regarding audit; (xxi) deliver CPA audit to responsible-fiduciary and chairman of fiduciary board; (xxii) provide chairman of fiduciary board with other periodic reports; (xxiii) review plan compliance generally; (xxiv) review compliance tests and report findings to responsible-fiduciary and chairman of fiduciary board; (xxv) review form 5500 and schedules; and (xxvi) deliver signature ready 5500/schedules to responsible-fiduciary.

### F. Fiduciary Discretion and Responsibility

A fiduciary entity 14 according to the present disclosure, through its association with a responsible-fiduciary 34 and one or more other individual fiduciaries 30, may be described as having all effective fiduciary discretion and responsibility for management of a given retirement plan. As used herein, the phrase “all effective fiduciary discretion and responsibility,” means all possible fiduciary discretion and responsibility that may be legitimately delegated, transferred, assigned, or otherwise given to a fiduciary entity from a co-sponsor. For example, “all effective fiduciary discretion and responsibility,” does not include the co-sponsor's right to terminate the co-sponsor/fiduciary entity relationship. This situation resulting from the implementation of systems and/or methods according to the present disclosure may be described as FIDUCIARY ISOLATION™.

A fiduciary entity 14 may receive such all effective fiduciary discretion and responsibility through contract, agreement, or other device, with a co-sponsor. As used herein, “contract” means an agreement between two parties, or to agree with another party, and is not limited by jurisdictional law relating to what defines a valid and enforceable contract. For example, if a contract between a fiduciary entity 14 and a co-sponsor 16 is later determined to be legally (or equitably) invalid or unenforceable, the contract (whether void, unenforceable, invalid, etc.) is still considered a contract for purposes of the present disclosure.

Additionally or alternatively, a contract between a fiduciary entity and a co-sponsor may include indemnification of the co-sponsor from all liabilities associated with, or resulting from, the breach of fiduciary duties performed by the fiduciary entity.

A non-exclusive example of a contract establishing a relationship between a fiduciary entity 14 and a co-sponsor 16 is provided in Appendix G, below.

### III. Co-Sponsors and Participants

A co-sponsor 16 is an entity, such as a company, organization, or other association, having employees, members, or other associates that are considered participants 18 in an adopted retirement plan 12. That is, the co-sponsor is an entity that adopts, or has adopted, a retirement plan to provide retirement benefits to the co-sponsor's employees, members, or other associates (i.e., participants 18). Participants 18 may also be described as participating individuals, eligible participants, eligible employees, eligible members, or beneficiaries. However, “beneficiary” may also refer to an individual designated by a participant to receive his/her retirement benefits should the participant pass away.

Non-exclusive examples of entities that may be considered a co-sponsor for purposes of the present disclosure include, but are not limited to, an employer company having employees and an association having members (e.g., a union or other trade association that provides benefits to its members). As used herein, “co-sponsor” encompasses existing co-sponsors, co-sponsors to be formed, as well as dissolved co-sponsors (e.g., an employer co-sponsor having since gone out of business). In the instance of a dissolved co-sponsor, the systems and methods according to the present disclosure are still applicable. For example, a trust or other device or entity may be, or may have been, formed to replace the co-sponsor for purposes of continuing administration of a retirement plan for the former co-sponsor's participants. In such situations, a retirement plan may also be described as an orphan plan.

As illustrated in FIG. 1, a co-sponsor may (though is not required to) include one or more of directors 42, officers 44, and a human resources department 46, for example in the instance of a co-sponsor being an employer company. Such directors, officers, and/or human resources department may be responsible for various aspects of the operation of the company and may have responsibilities associated with the administration of an adopted retirement plan 12. For example, the directors or officers may be charged with selecting a sponsor and a retirement plan to provide to the company's employees. In other words, the directors and/or officers may have the discretion to contract with a fiduciary entity 14 and adopt a retirement plan 12. Similarly, the directors and/or officers may have the discretion to terminate an existing relationship between the company and a fiduciary entity 14. Such discretion may be provided explicitly or inherently in the company's corporate charter or by-laws, for example. As discussed above, the discretion to terminate an existing relationship between a co-sponsor and a fiduciary entity does not fall within the all effective fiduciary discretion and responsibility for management of a given retirement plan that may be legitimately delegated, transferred, assigned, or otherwise given to a fiduciary entity from a co-sponsor through contract. Stated differently, in regards to co-sponsor discretion related to providing a retirement plan to its participating individuals, the co-sponsor (under systems and methods according to the present disclosure) may be described as having only the discretion to hire and fire a fiduciary entity.

A human resources department 46 may be charged with non-fiduciary administrative tasks associated with providing a retirement plan 12 to participants 18. For example, such non-fiduciary administrative tasks may include, but are not limited to, enrolling participants, maintaining files associated with participants' accounts in the retirement plan, etc. Implementation of systems and methods according to the present disclosure may prohibit and/or prevent members of a human resources department from making any discretionary decisions relating to the management of an adopted retirement plan.

As discussed above, under systems and methods according to the present disclosure, a co-sponsor 16 may—by contract—delegate, transfer, assign, or otherwise give to a fiduciary entity 14, all effective fiduciary discretion and responsibility associated with management of an adopted, or to-be-adopted, retirement plan. Such a contract may require the co-sponsor (or its officers, directors, or their equivalents) to pass a resolution wherein the co-sponsor agrees that all effective fiduciary discretion and responsibility will reside with the fiduciary entity. Stated differently, such a contract may require the co-sponsor to stipulate to the isolation of fiduciary discretion and responsibility with the fiduciary entity. Additionally, the co-sponsor may further agree, or be required to agree, that no director, officer, manager, or other employee of the co-sponsor shall retain fiduciary discretion or authority to act on behalf of the retirement plan or its participants and beneficiaries. A non-exclusive example of such a resolution is provided in Appendix H, below.

An additional or alternative mechanism for isolating the all effective fiduciary discretion and responsibility from a co-sponsor to a fiduciary entity includes requiring the co-sponsor (e.g., through its board of directors (corporation), managing members (LLC), or equivalents) to submit to its shareholders, members, or equivalents, a vote wherein all effective fiduciary discretion and responsibility is removed from the co-sponsor's directors, officers, members, employees, etc.

Other mechanisms, devices, methods, etc. of isolating fiduciary discretion and responsibility from directors, officers, members, employees, etc. of a co-sponsor are equally within the scope of the present disclosure.

A non-exclusive example of an adoption agreement between a fiduciary entity 14 and a co-sponsor 16 is provided in Appendix I, below. A non-exclusive example of a formal record of action is provided in Appendix J, below.

### IV. Investment Managers

An investment manager 20 may be responsible for managing a portfolio associated with a retirement plan 12, for example a portfolio comprising the trust of a retirement plan. In other words, an investment manager associated with a given retirement plan 12 may be responsible for the day-to-day direction of buying and selling of securities and other assets held by a retirement plan for the benefit of the participants. The investment manager manages the portfolio according to the provisions of the retirement plan and under the direction of the fiduciary entity.

A fiduciary entity 12 may, in addition to it roles described in detail above, fulfill the role of an investment manager 20. Additionally or alternatively, the investment manager may be a separate entity or individual that contracts with the fiduciary entity to provide its services.

### V. Custodians of Funds

A custodian of funds 22 is an entity that provides services of maintaining the account(s) associated with a retirement plan and its trust, settling transactions directed by the investment manager 20, providing regular statements to participants of a retirement plan as well as to the fiduciary entity sponsoring the retirement plan, etc. A non-exclusive example of a company that may fulfill the role of a custodian of funds 22 for purposes of the present disclosure includes THE CHARLES SCHWAB CORPORATION.

Like an investment manager 20, a custodian of funds 22 may be separate from a fiduciary entity 12 and provide its services in accordance with a contract with the fiduciary entity. Alternatively, a fiduciary entity 12 may, in addition to its roles described in detail above, fulfill the role of a custodian of funds. In other words, though not required, it is within the scope of the present disclosure that a single entity may fulfill the roles of one or more of a fiduciary entity 12, an investment manager 20, and a custodian of funds 22 with respect to a retirement plan 12.

### VI. Methods

Implementation of systems and sub-systems according to the present disclosure may be described in terms of methods and/or steps of methods. Such methods and/or steps of methods may be performed by the various entities and/or individuals associated with the various systems and/or sub-systems according to the present disclosure and described above.

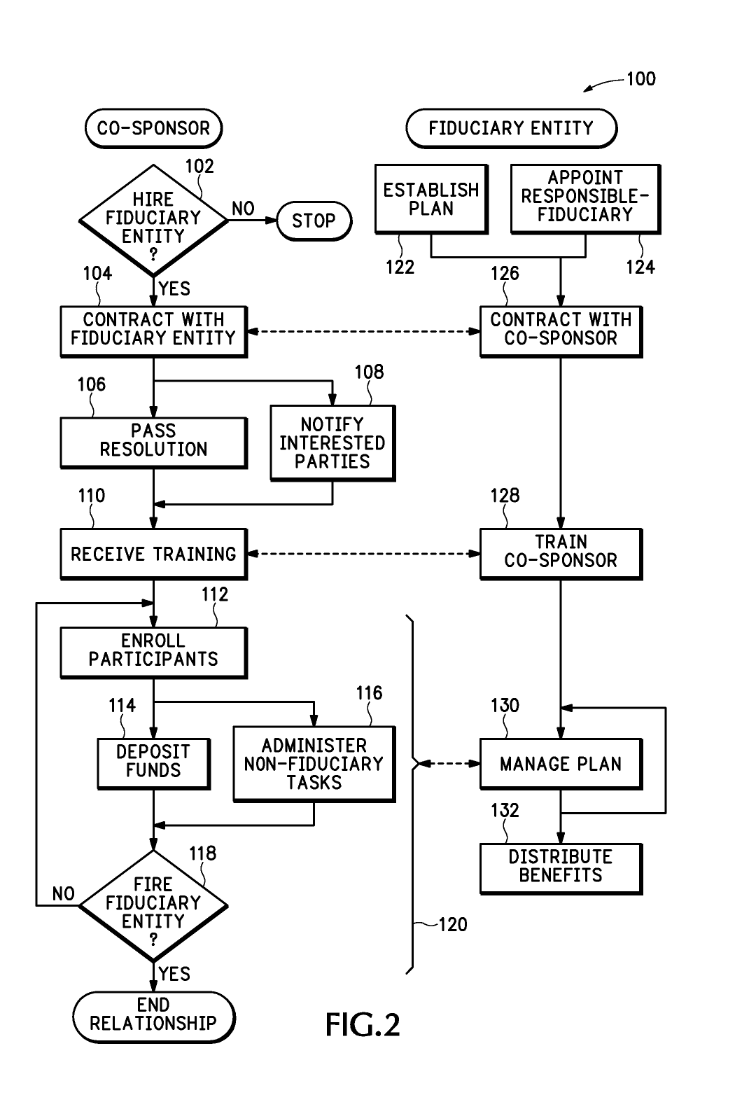

FIG. 2 broadly illustrates methods and steps of methods that may be performed by a co-sponsor and/or a fiduciary entity. For example, as illustrated, a co-sponsor may decide whether or not to hire a fiduciary entity for the purposes of providing a retirement plan to its participating individuals (e.g., employees of an employer co-sponsor), as indicated at 102. If the co-sponsor decides to hire a fiduciary entity, the co-sponsor may then contract with the fiduciary entity, as indicated at 104 and described in more detail above, to adopt a retirement plan and form the relationship between the co-sponsor and the fiduciary entity. After contracting with the fiduciary entity, the co-sponsor may then pass a resolution, as indicated at 106, or perform another necessary action to effectively isolate all effective fiduciary discretion and responsibility from the co-sponsor to the fiduciary entity, as discussed in more detail above.

As indicated at 108, the co-sponsor may notify all interested parties including, but not limited to, participants (e.g., employees of an employer co-sponsor), the co-sponsor's previous retirement plan sponsor, etc. Next, the co-sponsor may receive necessary training from the fiduciary entity regarding administration of the adopted retirement plan, as indicated at 110. For example, such training may include training of the co-sponsor's human resources department or other employees that will be involved with the non-fiduciary administration of the retirement plan.

Once the co-sponsor has been appropriately trained, participants may then be enrolled in the retirement plan, as indicated at 112, and funds may be deposited into the retirement plan, as indicated at 114, for example by the co-sponsor and/or by deductions from participants' pay checks. During the on-going administration of the plan, the co-sponsor administers non-fiduciary tasks, as indicated at 116.

As discussed in more detail above, the co-sponsor retains the fiduciary discretion to terminate the co-sponsor/fiduciary entity relationship, as indicated at 118. If the co-sponsor chooses to end the relationship, appropriate steps may be taken. If the co-sponsor chooses to maintain the relationship with the fiduciary entity, then the day-to-day administration of the retirement plan may continue as generally indicated at 120.

A non-exclusive example of a method according to the present disclosure and performed by a co-sponsor may be described as a method for isolating potential liability associated with providing a retirement plan to a co-sponsor's participating individuals, comprising: delegating all effective fiduciary discretion and responsibility associated with management of the retirement plan to a fiduciary entity, wherein the fiduciary entity is separate from the co-sponsor.

As illustrated in FIG. 2, a fiduciary entity may establish a retirement plan, as indicated at 122; appoint a responsible-fiduciary, as indicated at 124; contract with a co-sponsor, as indicated at 126; train the co-sponsor regarding administration of the adopted retirement plan, as indicated at 128; and manage the retirement plan according to the plan's guidelines and policies, as indicated at 130, including distributing benefits to beneficiaries, as indicated at 132. As generally indicated by dashed double-arrows in FIG. 2, various steps of methods performed by a fiduciary entity may correspond to various steps of methods performed by a co-sponsor.

A non-exclusive example of a method according to the present disclosure and performed by a fiduciary entity may be described as a method of providing a retirement plan for a co-sponsor's participating individuals, the method comprising: contracting with the co-sponsor wherein the co-sponsor delegates all effective fiduciary discretion and responsibility for the management of the retirement plan to the fiduciary entity; and directing investment of retirement plan funds according to a predetermined methodology.

Additionally or alternatively, a method according to the present disclosure and performed by a fiduciary entity may be described as a method of providing a retirement plan to a co-sponsor's participating individuals, the method comprising: contracting with the co-sponsor wherein the fiduciary entity agrees to assume all effective fiduciary discretion and responsibility associated with management of the retirement plan.

Methods, steps of methods, systems, and/or sub-systems and/or portions thereof according to the present disclosure may be implemented electronically. For example, enrollment of sponsors, employers, employees, or other parties may be handled electronically, for example via the internet. Other forms of electronic implementation are also within the scope of the present disclosure.

The following lettered paragraphs represent non-exclusive ways of describing systems and methods according to the present disclosure:

A A system for providing retirement benefits for a co-sponsor's participants, the system comprising: a retirement plan managed according to a predetermined investment methodology; and a fiduciary entity, separate from the co-sponsor, having all effective fiduciary discretion and responsibility for management of the retirement plan.

A0 The system of paragraph A, wherein the retirement plan includes a trust with a trustee and wherein the fiduciary entity fulfills the role of the trustee.

A0.1 The system of paragraph A0, wherein the fiduciary entity fulfills the role of the trustee according to a contract.

A1 The system of paragraph A, wherein the fiduciary entity assumed the fiduciary discretion and responsibility from the co-sponsor by contract.

A2 The system of paragraph A, wherein the fiduciary entity assumed the effective fiduciary discretion and responsibility from the co-sponsor by a contract requiring the co-sponsor to pass a resolution wherein the co-sponsor agrees that no director, officer, manager, or other employee of the co-sponsor shall retain fiduciary discretion or authority to act on behalf of the retirement plan or its participants and beneficiaries and further wherein the co-sponsor agrees that all effective fiduciary discretion and responsibility will reside with the fiduciary entity.

A2.1 The system of paragraph A2, wherein in the resolution the co-sponsor further agrees that concerns by participants pertaining to fiduciary activities, duties, and responsibilities shall not be discussed between individual employees of the co-sponsor, nor shall any employee act unilaterally to resolve such concerns.

A3 The system of paragraph A, wherein a responsible-fiduciary is associated with the fiduciary entity and is ultimately responsible for all effective fiduciary decisions regarding the retirement plan.

A3.1 The system of paragraph A3, wherein the responsible-fiduciary is employed by the fiduciary entity.

A3.2 The system of paragraph A3, wherein the responsible-fiduciary is an independent contractor for the fiduciary entity.

A3.2 The system of paragraph A3, wherein the retirement plan includes a trust with a trustee and wherein the responsible-fiduciary fulfills the role of the trustee.

A4 The system of paragraph A, wherein a fiduciary board is associated with the fiduciary entity and includes at least a responsible-fiduciary that is ultimately responsible for all effective fiduciary decisions made regarding the retirement plan.

A4.1 The system of paragraph A4, wherein an investment-fiduciary is associated with the fiduciary board and is responsible for monitoring investment of the retirement plan's funds for compliance with the retirement plan's guidelines and fiduciary standards.

A4.2 The system of paragraph A4, wherein an administrative-fiduciary is associated with the fiduciary board and is responsible for monitoring the receipt and disbursement of retirement plan funds.

A4.3 The system of paragraph A4, wherein a process-fiduciary is associated with the fiduciary board and is responsible for monitoring the activities of other board members associated with their respective delegated responsibilities.

A5 The system of paragraph A, wherein the retirement plan includes retirement plan funds; and wherein the predetermined investment methodology includes investment of the retirement plan funds according to a nationally-recognized prudent retirement investment strategy.

A6 The system of paragraph A, wherein the retirement plan includes retirement plan funds; and wherein the predetermined investment methodology includes investment of the retirement plan funds according to Harry Markowitz' Modern Portfolio Theory and subsequent evolutionary thought.

A7 The system of paragraph A, wherein the retirement plan includes retirement plan funds; and wherein the predetermined investment methodology includes investment in the range of about 30-50% of the retirement plan funds in broad fixed-income investments, investment in the range of about 50-70% of retirement plan funds in large cap equity investments, and investment in the range of about 0-10% of retirement plan funds in cash instruments.

A8 The system of paragraph A, wherein the retirement plan includes retirement plan funds; and wherein the predetermined investment methodology includes investment of approximately 40% of retirement plan funds in broad fixed-income investments, and investment of approximately 60% of retirement plan funds in large cap equity investments.

A9 The system of paragraph A, wherein the co-sponsor is an employer with participating employees.

A10 The system of paragraph A, wherein the co-sponsor is an association with participating members.

B A mechanism for removing risk of mismanaging a retirement plan from a co-sponsor's directors, officers, managers, and employees, comprising: a fiduciary entity, separate from the co-sponsor; and a device that transfers all effective management authority and discretion from the co-sponsor to the fiduciary entity.

C A system for providing a retirement plan for a co-sponsor's participating individuals, comprising: a fiduciary entity, separate from the co-sponsor; and a contract between the fiduciary entity and the co-sponsor, wherein the fiduciary entity agrees to assume all effective fiduciary discretion and responsibility associated with management of the retirement plan.

D A system for providing a retirement plan, comprising: a fiduciary entity that contracts with co-sponsors to provide the retirement plan, manage the retirement plan, and assume all effective fiduciary discretion and responsibility associated with management of the retirement plan.

E A method of providing a retirement plan for a co-sponsor's participating individuals, the method being performed by a fiduciary entity and comprising: contracting with the co-sponsor wherein the co-sponsor delegates all effective fiduciary discretion and responsibility for the management of the retirement plan to the fiduciary entity; and directing investment of retirement plan funds according to a predetermined methodology.

E1 The method of paragraph E, wherein contracting includes indemnifying the co-sponsor of liabilities resulting from the breach of fiduciary duties performed by the fiduciary entity.

E2 The method of paragraph E, wherein contracting includes receiving, from the co-sponsor, an assignment of all liability associated with the all effective fiduciary discretion and responsibility.

E3 The method of paragraph E, wherein contracting includes requiring the co-sponsor to pass a resolution wherein the co-sponsor agrees that no director, officer, manager, or other employee of the co-sponsor shall retain any effective fiduciary discretion or authority to act on behalf of the retirement plan or its participants and beneficiaries and further wherein the co-sponsor agrees that all effective fiduciary discretion will reside with the fiduciary entity.

E4 The method of paragraph E, wherein contracting includes requiring the co-sponsor to pass a resolution wherein the co-sponsor agrees that concerns by participants of the retirement plan pertaining to fiduciary activities, duties, and responsibilities shall not be discussed between individual employees, nor shall any employee act unilaterally to resolve such concerns.

E5 The method of paragraph E, further comprising: appointing a responsible-fiduciary wherein the responsible-fiduciary is ultimately responsible for all fiduciary decisions made regarding the retirement plan.

E6 The method of paragraph E, further comprising: appointing a fiduciary board including at least a responsible-fiduciary ultimately responsible for all fiduciary decisions made regarding the retirement plan.

E6.1 The method of paragraph E6, wherein the fiduciary board further includes an investment-fiduciary, and the method further comprises: monitoring, by the investment-fiduciary, investment of the retirement plan funds for compliance with retirement plan guidelines and fiduciary standards; and reporting, by the investment-fiduciary to the responsible-fiduciary, observations associated with the investment-fiduciary's monitoring.

E6.2 The method of paragraph E6, wherein the fiduciary board further includes an administrative-fiduciary, and the method further comprises: monitoring, by the administrative-fiduciary, receipt and disbursement of the retirement plan funds and records associated therewith; and reporting, by the administrative-fiduciary to the responsible-fiduciary, observations associated with the administrative-fiduciary's monitoring.

E6.3 The method of paragraph E6, wherein the fiduciary board further includes a process-fiduciary, and the method further comprises: monitoring, by the process-fiduciary, activities of other board members associated with their respective delegated responsibilities; and reporting, by the process-fiduciary to the responsible-fiduciary, observations associated with the process-fiduciary's monitoring.

E7 The method of paragraph E, wherein the predetermined methodology includes investing the retirement plan funds according to a nationally-recognized prudent retirement investment strategy.

E8 The method of paragraph E, wherein the predetermined methodology includes investing the retirement plan funds according to Harry Markowitz' Modern Portfolio Theory and subsequent evolutionary thought.

E9 The method of paragraph E, wherein the predetermined methodology includes maintaining in the range of about 30-50% of the retirement plan funds invested in broad fixed-income investments, in the range of about 50-70% of the retirement plan funds invested in large cap equity investments, and in the range of about 0-10% of the retirement plan funds invested in cash instruments.

E10 The method of paragraph E, wherein the predetermined methodology includes investing approximately 40% of the retirement plan funds in broad fixed-income investments, and approximately 60% of the retirement plan funds in large cap equity investments.

F A method of providing a retirement plan to a co-sponsor's participating individuals, the method being performed by a fiduciary entity and comprising: contracting with the co-sponsor wherein the fiduciary entity agrees to assume all effective fiduciary discretion and responsibility associated with management of the retirement plan.

G A method of isolating potential liability associated with providing a retirement plan to a co-sponsor's participating individuals, the method being performed by the co-sponsor and comprising: delegating all effective fiduciary discretion and responsibility associated with management of the retirement plan to a fiduciary entity, wherein the fiduciary entity is separate from the co-sponsor.

The present disclosure, including the appendices presented below, encompasses multiple distinct inventions with independent utility. While each of these inventions has been disclosed in a preferred form or method, the specific alternatives, embodiments, and/or methods thereof as disclosed and illustrated herein are not to be considered in a limiting sense, as numerous variations are possible. The present disclosure includes all novel and non-obvious combinations and subcombinations of the various elements, features, functions, properties, methods, steps, systems, and/or sub-systems disclosed herein. Similarly, where the disclosure recites “a” or “a first” element, step of a method, or the equivalent thereof, such disclosure should be understood to include one or more such elements or steps, neither requiring nor excluding two or more such elements or steps.

Inventions embodied in various combinations and subcombinations of features, functions, elements, properties, steps, methods, sub-systems, and/or systems may be claimed through presentation of claims in a related application. Such claims, whether they are directed to a different invention or directed to the same invention, whether different, broader, narrower, or equal in scope to the original claims, are also regarded as included within the subject matter of the present disclosure.

The various section and subsection titles used herein are provided as a convenience to the reader and are not limiting in anyway.

The present disclosure makes reference to various United States statutes and regulations. Such statutes and regulations are provided for context only (i.e., for understanding implementation of the various methods and/or systems according to the present disclosure). Such laws and regulations may change over time, and the methods and/or systems associated therewith may change accordingly to correspond with amended and/or new statutes or regulations and still be within the scope of the present disclosure. Furthermore, similar, dissimilar, or related statutes or regulations, or equivalents thereof, of countries or jurisdictions other that the United States may equally correspond to methods and/or systems according to the present disclosure. The methods and systems according to the present disclosure are not limited to implementation in the United States.

### APPENDICES

These appendices represent various non-exclusive examples of documents (collectively “sample copy”) that may be used in implementing methods, steps of methods, systems, and/or sub-systems according to the present disclosure (e.g., by or for interaction between various parties including, but not limited to, principal plan sponsors, co-sponsors, vendors, employers, employees, banks, brokerage firms, financial institutions, fiduciaries, prospective parties, third parties, etc.). This sample copy is provided as non-exclusive examples only and is not limiting. In other words, methods, steps of methods, systems, and/or sub-systems according to the present disclosure are not limited to the exact wording, format, numerical values, configuration, type of document, etc. of the sample copy. Other implementation of the various methods, steps of methods, systems, and/or sub-systems embodied in the sample copy is equally within, and does not depart from, the scope of the present disclosure. The contents of all the appendices should be considered subject matter of the present disclosure and is not limited to only being embodied in documents.

Various trademarks and service marks are referred to in these appendices and are associated with implementing the methods, steps of methods, systems, and/or sub-systems according to this disclosure. Those trademarks and service marks are not intended to be limiting in any way, and as used herein may be substituted by a generic equivalent. For example, as used herein, “G FIDUCIARY, LLC” and its equivalents (G|FIDUCIARY, G FIDUCIARY, etc.) may be considered a fiduciary entity, a principal plan sponsor, a plan sponsor, a sponsor, a manager, an independent fiduciary or other appropriate designation as may be appropriate for the particular context in which it is used. Similarly, a retirement plan according to the present disclosure may be referred to in these appendices as the G|PLAN, the G FIDUCIARY PLAN, the G FIDUCIARY RETIREMENT INCOME SECURITY PLAN, the Plan, or other designation.

Some of these appendices make reference to various numerical values including, but not limited to, dollar amounts, rates of return, percentages of various values, etc. Such numerical values are provided as examples only, and the present disclosure is not limited to such numerical values. Other values are equally within the scope of the present disclosure.

Some of these appendices make reference to various acronyms and abbreviations of various components of systems and/or methods. Each of those acronyms and abbreviations has the ordinary meaning to those of ordinary skill in the appropriate art.

Finally, in the event that any of these appendices define or use a term or terms in a manner inconsistent with either the portions of the detailed description above or with any of the other appendices, the term or terms as used therein only control with respect to the appendix in which the term or terms are used or defined.

1. A system for providing retirement benefits for a co-sponsor's participants, the system comprising:
a retirement plan managed according to a predetermined investment methodology; and
a fiduciary entity, separate from the co-sponsor, having all effective fiduciary discretion and responsibility for management of the retirement plan.

2. The system of claim 1,
wherein the retirement plan includes a trust with a trustee and wherein the fiduciary entity fulfills the role of the trustee.

3. The system of claim 1,
wherein the fiduciary entity assumed the fiduciary discretion and responsibility from the co-sponsor by contract.

4. The system of claim 1,
wherein the fiduciary entity assumed the effective fiduciary discretion and responsibility from the co-sponsor by a contract requiring the co-sponsor to pass a resolution wherein the co-sponsor agrees that no director, officer, manager, or other employee of the co-sponsor shall retain fiduciary discretion or authority to act on behalf of the retirement plan or its participants and beneficiaries and further wherein the co-sponsor agrees that all effective fiduciary discretion and responsibility will reside with the fiduciary entity.

5. The system of claim 4,
wherein in the resolution the co-sponsor further agrees that concerns by participants pertaining to fiduciary activities, duties, and responsibilities shall not be discussed between individual employees of the co-sponsor, nor shall any employee act unilaterally to resolve such concerns.

6. The system of claim 1,
wherein a responsible-fiduciary is associated with the fiduciary entity and is ultimately responsible for all effective fiduciary decisions regarding the retirement plan.

7. The system of claim 6,
wherein the responsible-fiduciary is employed by the fiduciary entity.

8. The system of claim 6,
wherein the responsible-fiduciary is an independent contractor for the fiduciary entity.

9. The system of claim 6,
wherein the retirement plan includes a trust with a trustee and wherein the responsible-fiduciary fulfills the role of the trustee.

10. The system of claim 1,
wherein a fiduciary board is associated with the fiduciary entity and includes at least a responsible-fiduciary that is ultimately responsible for all effective fiduciary decisions made regarding the retirement plan.

11. The system of claim 10,
wherein an investment-fiduciary is associated with the fiduciary board and is responsible for monitoring investment of the retirement plan's funds for compliance with the retirement plan's guidelines and fiduciary standards.

12. The system of claim 10,
wherein an administrative-fiduciary is associated with the fiduciary board and is responsible for monitoring the receipt and disbursement of retirement plan funds.

13. The system of claim 10,
wherein a process-fiduciary is associated with the fiduciary board and is responsible for monitoring the activities of other board members associated with their respective delegated responsibilities.

14. The system of claim 1,
wherein the retirement plan includes retirement plan funds; and
wherein the predetermined investment methodology includes investment of the retirement plan funds according to a nationally-recognized prudent retirement investment strategy.

15. The system of claim 1,
wherein the retirement plan includes retirement plan funds; and
wherein the predetermined investment methodology includes investment of the retirement plan funds according to Harry Markowitz' Modern Portfolio Theory and subsequent evolutionary thought.

16. The system of claim 1,
wherein the retirement plan includes retirement plan funds; and
wherein the predetermined investment methodology includes investment in the range of about 30-50% of the retirement plan funds in broad fixed-income investments, investment in the range of about 50-70% of retirement plan funds in large cap equity investments, and investment in the range of about 0-10% of retirement plan funds in cash instruments.

17. The system of claim 1,
wherein the retirement plan includes retirement plan funds; and
wherein the predetermined investment methodology includes investment of approximately 40% of retirement plan funds in broad fixed-income investments, and investment of approximately 60% of retirement plan funds in large cap equity investments.

18. The system of claim 1, wherein the co-sponsor is an employer with participating employees.

19. The system of claim 1, wherein the co-sponsor is an association with participating members.

20. A mechanism for removing risk of mismanaging a retirement plan from a co-sponsor's directors, officers, managers, and employees, comprising:
a fiduciary entity, separate from the co-sponsor; and
a device that transfers all effective management authority and discretion from the co-sponsor to the fiduciary entity.

21. A system for providing a retirement plan for a co-sponsor's participating individuals, comprising:
a fiduciary entity, separate from the co-sponsor; and
a contract between the fiduciary entity and the co-sponsor, wherein the fiduciary entity agrees to assume all effective fiduciary discretion and responsibility associated with management of the retirement plan.

22. A system for providing a retirement plan, comprising:
a fiduciary entity that contracts with co-sponsors to provide the retirement plan, manage the retirement plan, and assume all effective fiduciary discretion and responsibility associated with management of the retirement plan.

23. A method of providing a retirement plan for a co-sponsor's participating individuals, the method being performed by a fiduciary entity and comprising:
contracting with the co-sponsor wherein the co-sponsor delegates all effective fiduciary discretion and responsibility for the management of the retirement plan to the fiduciary entity; and
directing investment of retirement plan funds according to a predetermined methodology.

24. The method of claim 23,
wherein contracting includes receiving, from the co-sponsor, an assignment of all liability associated with the all effective fiduciary discretion and responsibility.

25. The method of claim 23,
wherein the predetermined methodology includes investing the retirement plan funds according to a nationally-recognized prudent retirement investment strategy.
